(19) United States
(12) Patent Application Publication
(10) Pub. No.: US 2007/0017308 A1
(43) Pub. Date: Jan. 25, 2007

(54) Manipulation device of microwave oven

(76) Inventor: Yoon Gun Baek, Kyungsangnam-do (KR)

Correspondence Address: FLESHNER & KIM, LLP, P.O. BOX 221200, CHANTILLY, VA, 20153, US

(21) Appl. No.: 10/567,604

(22) PCT Filed: Jan. 25, 2005
(86) PCT No.: PCT/KR05/00197

§ 371 Date: Feb. 8, 2006

(30) Foreign Application Priority Data
Feb. 13, 2004 (KR) 10-2004-0009561

(51) Int. Cl. F16H 35/18

(52) U.S. Cl. 74/10 R

(57) ABSTRACT

There is provided a manipulation device of a microwave oven. In the manipulation device, a coupling shaft of a dial knob includes a guide rib on its outer surface, a coupling tab extending from a leading end of the guide rib, and a reinforcement rib formed on a side of the guide rib. Therefore, the coupling shaft can be protected from an excessive force acted on the dial knob.

### TECHNICAL FIELD

The present invention relates to a manipulation device of a microwave oven, and more particularly, to a control panel of a microwave oven in which coupling structure of a dial knob and an output adjusting gear is improved to increase durability.

### BACKGROUND ART

A microwave oven is a cooling appliance in which a magnetron converts electrical energy into microwave and applies the microwave to food or other objects to be heated. The microwave oven is usually placed on a piece of kitchen furniture to use it at the kitchen. Also, a microwave oven combined with a hood may be placed above a gas range to cook the food and exhaust smoke or fumes.

Meanwhile, the users can set or adjust cooking time by rotating a dial knob extended from a front control panel of the microwave oven.

FIG. 1 is a sectional view of a dial knob according to the related art.

Referring to FIG. 1, a dial knob 20 is mounted on a control panel 40 of a microwave oven.

The dial knob 20 has a circular barrel shape and includes a coupling shaft 22 extending from an inner center with a predetermined length. The coupling shaft 22 is to be coupled with an output adjusting gear (not shown) that is installed inside of the control panel 40.

The coupling shaft 22 defines a coupling hole 24 at its leading end to receive a coupling member such as a screw. The coupling shaft 22 has a circular section of which some portion is cut off. The output adjusting gear defines a shaft hole at a center portion to receive the coupling shaft 20. Therefore, when the coupling shaft 22 is inserted into the shaft hole, the output adjusting gear can be rotated by rotating the dial knob 20.

Further, a coupler gear (not shown) is interposed between the output adjusting gear and a control circuit gear (not shown) controlling the output power of the microwave oven.

The operation of the dial knob assembly will not be described briefly.

When the user rotates the dial knob 20 to set cooking temperature or heating intensity (output power) of the microwave oven, the output adjusting gear coupled with the coupling shaft 22 of the dial knob 20 is rotated proportionally to the rotation of the dial knob 20. The rotation of the output adjusting gear causes the coupler gear to rotate.

Dial knobs having the same or similar structures as mentioned above are disclosed in Korean Patent Laid-Open Nos. 10-2003-0079583 and 10-2003-0085887, applied by the present applicant of the present invention.

However, the dial knob of the related art has some disadvantages.

The shaft 22 of the dial knob 20 has a circular section of which some portion is cut off, and defines the coupling hole 24 for coupling with the coupling member to prevent detachment of the dial knob 20 from the output adjusting gear. Therefore, the section of the shaft 22 around the coupling hole 24 is not uniform. This non-uniform section may cause a crack at a narrower portion when the coupling member is inserted.

Further, rotating the dial knob 20 with an excessive force may cause a crack at the narrower section of the coupling shaft 22, and once the crack is formed it may be easily developed even when the dial knob 20 is gently rotated, thereby breaking the coupling shaft 22 and causing malfunction of the dial knob 20.

### DISCLOSURE OF INVENTION

Technical Problem

Accordingly, the present invention is directed to a manipulation device of a microwave oven that substantially obviates one or more of the problems due to limitations and disadvantages of the related art.

An object of the present invention is to provide a manipulation device of a microwave oven, in which coupling structure of a dial knob and an output adjusting gear is improved to prevent breakage of a coupling shaft of the dial knob.

Another object of the present invention is to provide a manipulation device of a microwave oven, in which rotation of a dial knob is restricted within a predetermined range to prevent breakage of a coupling shaft of the dial knob, such that the dial knob can be used without malfunction.

Technical Solution

To achieve these and other advantages and in accordance with the purpose of the present invention, as embodied and broadly described, there is provided a manipulation device of a microwave oven, including: a control panel; a dial knob stably mounted on the control panel, the dial knob including a coupling shaft formed at a center portion with a predetermined length and at least one guide rib formed on an outer surface of the coupling shaft; and an output adjusting gear coupled with the dial knob.

According to another aspect of the present invention, there is provided a manipulation device of a microwave oven, including: a dial knob; a coupling shaft extended from a center of the dial knob with a predetermined length; an output adjusting gear having a shaft hole in which the coupling shaft is inserted; a control panel in which the dial knob is rotatably inserted; and a coupling member fixing the output adjusting gear to the dial knob, for an integral rotation of the output adjusting gear with the dial knob.

According to a further another aspect of the present invention, there is provided a manipulation device of a microwave oven, including: a dial knob; an output adjusting gear coupled with the dial knob for transmitting the rotation motion of the dial knob; a control panel having a knob hole in which the dial knob is rotatably inserted and a stop projection extending from a circumference of the knob hole toward a center of the knob hole; and a coupling member for the coupling of the dial knob and the output adjusting gear.

Advantageous Effects

According to the present invention, a manipulation device of a microwave oven is designed such that a dial knob of the manipulation device is not cracked even when it is excessively rotated, thereby increasing durability and reliability.

### BRIEF DESCRIPTION OF THE DRAWINGS

FIG. 1 is a sectional view of a dial knob according to the related art;

FIG. 2 is an exploded perspective view of a dial knob assembly according to the present invention;

FIG. 3 is a rear view of a dial knob according to the present invention;

FIG. 4 is a phantom view of a dial knob assembly according to the present invention; and

FIG. 5 is a sectional view of a dial knob assembly according to the present invention.

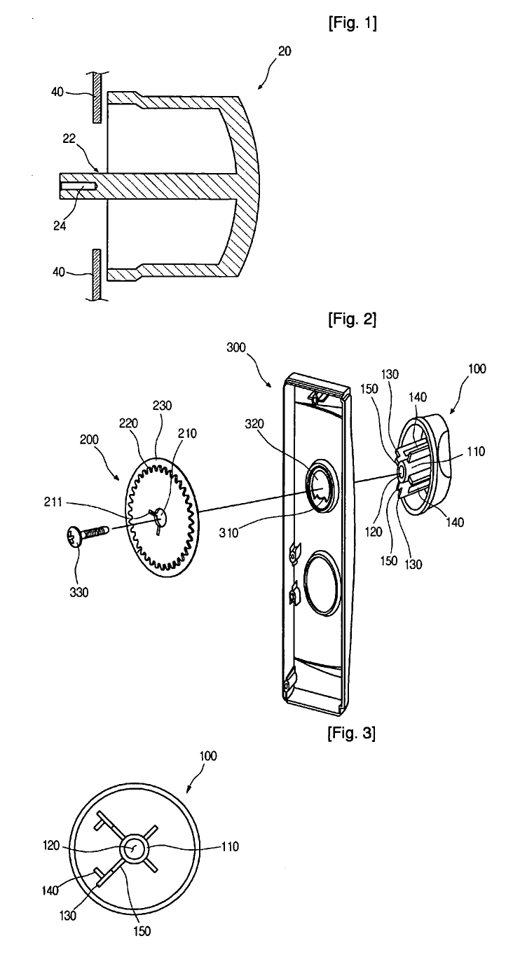

### BEST MODE FOR CARRYING OUT THE INVENTION

Hereinafter, preferred embodiments of the present invention will be described in detail with reference to accompanying drawings.

FIG. 2 is an exploded perspective view of a dial knob assembly according to the present invention.

Referring to FIG. 2, a dial knob assembly includes: a dial knob 100 which a user can rotate; a control panel 300 on which display devices are installed; an output adjusting gear 200 to be installed inside of the control panel 300 and coupled with the dial knob 100; and a screw 330 for fastening the output adjusting gear to the dial knob 100. The dial knob 100 is rotatably inserted in the control panel 300 (when assembled).

The dial knob 100 defines a recessed opening on the back and includes a cylindrical coupling shaft 110 protruded from a center of the recessed opening with a pre-determined length. The coupling shaft 110 defines a screw hole 120 having a pre-determined depth, in which a coupling member such as the screw 300 is to be inserted.

Further, the dial knob 100 includes at least one guide rib 130 (two are shown) formed on an outer surface of the coupling shaft 110 with a predetermined length and width, and includes a reinforcement rib 140 extended from a side of the guide rib 130 with a predetermined length. The guide rib 130 includes a coupling tab 150 at its leading end with a predetermined length. The width of the coupling tab 150 is somewhat smaller than that of the guide rib 130.

The rotational movement of the dial knob 100 is restricted by the guide rib 130 and a stop projection 310 (the stopping is distinctly shown in FIG. 4). That is, the dial knob 100 can be rotated until the guide rib 130 is abutted against the stop projection 310. The reinforcement rib 140 protects the guide rib 130 from an excessive force acted when the guide rib 130 is abutted against the stop projection 310. The coupling tab 150 is to be inserted in a tab slot 211 of the output adjusting gear 200. The width and length of the coupling tab 150 is not limited to the illustrated shape. For example, the width and length of the coupling tab 150 may be the same values as the guide rib 130. Also, it is apparent that the size of the tab slot 211 of the output adjusting gear 200 should be changed depending on the width of the coupling tab 150.

The control panel 300 includes a knob hole 320 and the stop projection 310. The dial knob 100 is inserted into the knob hole 320, and the stop projection 310 is extended toward the center of the knob hole 320 to restrict the rotation of the dial knob 100. The stop projection 310 is designed such that the guide rib 130 is abutted against the side of the stop projection 310 when the dial knob 100 is rotated a predetermined angle, thereby restricting the rotation of the dial knob 100.

The output adjusting gear 200 includes a shaft hole 210 and the tab slot 211. The shaft hole 210 is defined at a center portion of the output adjusting gear 200 to receive the coupling shaft 110 of the dial knob 100. The tab slot 211 (two are shown) is defined in a radial direction of the shaft hole 210 with a width corresponding to the width of the coupling tab 150, such that the coupling tab 150 can be inserted into the tab slot 211. Therefore, the coupling shaft 110 and the coupling tab 150 can be exactly inserted into the shaft hole 210 and the tab slot 211 respectively, such that the output adjusting gear 200 can be coupled with the dial knob 100.

Further, the output adjusting gear 200 includes gear teeth 220 at its circumference to engage with a coupler gear (now shown) that is engaged with a control circuit gear. The output adjusting gear 200 also includes a guide surface 230 that is extended from the gear teeth 220. The guide surface 230 has a less width than that of the gear teeth 220 but a large outer diameter than that of the gear teeth 220. The guide surface 230 supports the coupler gear to prevent disengagement of the coupler gear from the output adjusting gear 200.

The coupling member (screw 330) is to be inserted in the screw hole 120 of the coupling shaft 110 in order to secure the coupling of the dial knob 100 and the output adjusting gear 200.

The operation of the dial knob assembly will now be described.

Operating input values such as heating time and heating intensity (output power) are set using the dial knob 100. That is, the operation of the microwave oven is started by manipulating the dial knob 100.

When a user rotates the dial knob 100 to set operating input values such as cooking time and output power, the rotational force acted on the dial knob 100 by the user is transmitted to the shaft hole 210 through the coupling shaft 110 and the coupling tab 150. The transmitted force rotates the output adjusting gear 200. That is, rotation of the dial knob 100 causes the output adjusting gear 200 to rotate.

Further, the rotation of the output adjusting gear 200 causes the coupler gear to rotate, and the control circuit gear engaged with the coupler gear is also rotated. In the end, the cooking time and output power (operating input values) can be set by the rotation of the control circuit gear.

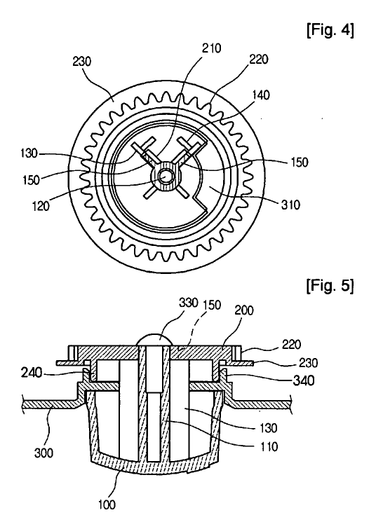

FIG. 3 is a rear view of a dial knob according to the present invention, and FIG. 4 is a phantom view of a dial knob assembly according to the present invention.

Referring to FIGS. 3 and 4, the dial knob 100 has a circular barrel shape with a pre-determined diameter and depth and is provided with the coupling shaft 110 extended from the inner center. The coupling shaft 110 includes the guide rib 130 (two are shown) formed in the radial direction with a predetermined radial width and axial length.

The reinforcement rib 140 is projected from one side of the guide rib 130 to enhance the strength of the guide rib 130. The other side of the guide rib 130 where the reinforcement rib 140 is not formed is to be brought into contact with the stop projection 310. Therefore, though a user excessively rotates the dial knob 100, the excessive load on the guide rib 130 can be transmitted to the reinforcement rib 140, such that the guide rib 130 can be protected from breakage. Most weak region, border between the coupling shaft 110 and the guide rib 130, can be protected well owing to the reinforcement rib 140.

FIG. 5 is a sectional view of a dial knob assembly according to the present invention.

Referring to FIG. 5, the dial knob 100 is mounted on the control panel 300, and the output adjusting gear 200 is coupled with the dial knob 100 from an inside of the control panel 300.

The control panel 300 includes an inwardly recessed surface and a circular receiving sleeve 340. On the inwardly recessed surface, the dial knob 100 is mounted. The circular receiving sleeve 340 is protruded from the opposite surface of the inwardly recessed surface with a predetermined length to receive the output adjusting gear 200. That is, the output adjusting gear 200 is inserted in the receiving sleeve 340 and is rotated when the dial knob 100 is rotated. Since the output adjusting gear 200 is inserted into the receiving sleeve 340, the output adjusting gear 200 can be prevented from separating from the control panel 300.

The teeth 220 are formed on a circumference of the output adjusting gear 200. The guide surface 230 is formed under the teeth 220 with a large diameter than that of the teeth 220. The output adjusting gear 200 includes a gear sleeve 240 protruded from a surface faced with the control panel 300.

The outer diameter of the gear sleeve 240 is the same as the inner diameter of the receiving sleeve 340 of the control panel 300, such that the gear sleeve 240 can be tightly inserted into the receiving sleeve 240. When the dial knob 100 is rotated, the gear sleeve 240 is also rotated in the receiving sleeve 340.

The coupling tab 150 is extended forwardly from the guide rib 130 with a pre-determined height. The coupling tab 150 is inserted into the tab slot 211 of the output adjusting gear 200. The screw 330 is inserted into the screw hole 120 formed in the coupling shaft 110.

The stop projection 310 of the control panel 300 restricts the rotation of the dial knob 100, such that the dial knob 100 is rotated within a restricted range. This restriction protects the coupling shaft from a crack.

According to the construction of the dial knob, the coupling shaft 110 can have a circular section. Also, in case the screw hole 120 is defined in the coupling shaft 110, the coupling shaft 110 can have a uniform section without a narrower portion. Therefore, stress concentration is not appeared when a force is acted on the coupling shaft 110, such that durability of the dial knob can be increased.

Further, the relationship between the guide rib 130 and the stop projection 310 restricts the rotation of the dial knob 100 within a predetermined range, such that operational reliability of the dial knob 100 can be increased.

Furthermore, the guide rib 130 and the reinforcement rib 140 enhances the strength of the dial knob 100, such that the dial knob 100 can be protected from the excessive force without breakage, thereby increasing durability of the dial knob 100.

### INDUSTRIAL APPLICABILITY

The dial knob of the present invention is designed such that the coupling shaft can have a circular section, and in case the screw hole is defined in the coupling shaft the coupling shaft can have a uniform section.

Therefore, the dial knob of the present invention can be applied to various home appliances such as microwave ovens and washing machines that require the dial knob to input operating set values.

1. A manipulation device of a microwave oven, comprising:
a control panel;
a dial knob stably mounted on the control panel, the dial knob including a coupling shaft formed at a center portion with a predetermined length and at least one guide rib formed on an outer surface of the coupling shaft; and
an output adjusting gear coupled with the dial knob.

2. The manipulation device according to claim 1, wherein the control panel comprises a recessed portion on which the dial knob is mounted.

3. The manipulation device according to claim 1, wherein the control panel comprises a knob hole at a predetermined location in which the dial knob is inserted for the stable mounting.

4. The manipulation device according to claim 3, wherein the control panel further comprises a stop projection protruded from a circumference of the knob hole toward a center of the knob hole to restrict a movement of the dial knob within a predetermined range.

5. The manipulation device according to claim 1, wherein a coupling member is inserted at an end of the coupling shaft to fix the output adjusting gear to the dial knob.

6. The manipulation device according to claim 1, wherein the coupling shaft comprises a hole at a leading end with a predetermined depth, for receiving a coupling member.

7. The manipulation device according to claim 1, wherein the guide rib comprises a coupling tab protruded from a leading end with a predetermined width and height.

8. The manipulation device according to claim 1, wherein the guide rib comprises a reinforcement rib formed at one side with a predetermined width and length.

9. A manipulation device of a microwave oven, comprising:
a dial knob;
a coupling shaft extending from a center of the dial knob with a predetermined length;
an output adjusting gear having a shaft hole in which the coupling shaft is inserted;
a control panel in which the dial knob is rotatably inserted; and
a coupling member fixing the output adjusting gear to the dial knob, for an integral rotation of the output adjusting gear with the dial knob.

10. The manipulation device according to claim 9, wherein the output adjusting gear comprises a tab slot extending from a circumference of the shaft hole with a pre-determined length.

11. The manipulation device according to claim 9, wherein the output adjusting gear comprises a guide surface for preventing an engaged gear from separating from the output adjusting gear.

12. The manipulation device according to claim 9, wherein the output adjusting gear comprises a guide surface on a back, an outer diameter of the guide surface being larger than an outer diameter of gear teeth of the output adjusting gear.

13. The manipulation device according to claim 9, wherein the coupling member is a screw of which outer surface is threaded.

14. The manipulation device according to claim 9, wherein the output adjusting gear comprises a gear sleeve formed at a back with a predetermined diameter and height.

15. The manipulation device according to claim 9, wherein the control panel comprises:
a mounting surface at one side on which the dial knob is stably mounted; and
a receiving sleeve formed on the other side with a predetermined diameter and height to stably receive the output adjusting gear.

16. The manipulation device according to claim 9, wherein the output adjusting gear comprises at least one slot extending radially from a circumference of the shaft hole with a predetermined length and width.

17. The manipulation device according to claim 9, wherein the output adjusting gear comprises at least one slot in which a rib formed on the coupling shaft is inserted, such that the dial knob is rotated integrally with the output adjusting gear without slip.

18. A manipulation device of a microwave oven, comprising:
a dial knob;
an output adjusting gear coupled with the dial knob for transmitting the rotation motion of the dial knob;
a control panel having a knob hole in which the dial knob is rotatably inserted and a stop projection extending from a circumference of the knob hole toward a center of the knob hole; and
a coupling member for the coupling of the dial knob and the output adjusting gear.

19. The manipulation device of claim 18, wherein rotational range of the dial knob inserted in the knob hole is determined by a width of the stop projection.

20. The manipulation device of claim 18, wherein the output adjusting gear comprises a guide surface on a side to prevent an engaged gear from separating from the output adjusting gear.
